(19) United States
(12) Patent Application Publication
(10) Pub. No.: US 2005/0223686 A1
(43) Pub. Date: Oct. 13, 2005

(54) Filter assembly and a vacuum cleaner having the same

(76) Inventor: Joo-seok Jeong, Gwangiu-city (KR)

Correspondence Address: LADAS & PARRY LLP, 224 SOUTH MICHIGAN AVENUE, SUITE 1600, CHICAGO, IL, 60604, US

(21) Appl. No.: 10/901,812

(22) Filed: Jul. 29, 2004

(30) Foreign Application Priority Data
Apr. 13, 2004 (KR) 2004-25180

(51) Int. Cl. B01D 46/00

(52) U.S. Cl. 55/497

(57) ABSTRACT

A filter assembly comprises a filter body for filtering dust and a filter housing for supporting the filter body. The filter body is configured in the form of a corrugation having alternate ridges and grooves, wherein a gap in the groove is blocked or shaped so as to prevent adhesion of the dust therein. Accordingly, detachment of the dust becomes easy when cleaning the filter body, and therefore, the filter assembly can maintain its performance as good as new one after being cleaned. A vacuum cleaner utilizing the filter assembly also provides the benefits of easy removal of the dust.

### CROSS-REFERENCE TO RELATED APPLICATIONS

This application claims the benefit of Korean Application No. 2004-25180, filed Apr. 13, 2004, in the Korean Intellectual Property Office, the disclosure of which is incorporated herein by reference.

### BACKGROUND OF THE INVENTION

1. Field of the Invention

The present invention relates generally to a vacuum cleaner and more particularly, to a filter assembly having an improved structure for more efficient cleaning, and a vacuum cleaner utilizing the same.

2. Description of the Related Art

Known vacuum cleaners consist of a cleaner body, a suction part for drawing in dirt on a surface being cleaned, an operational part for operating the vacuum cleaner, a connection pipe for connecting the suction part and the operational part, and a flexible hose for connecting the operational part to the cleaner body. The vacuum cleaners also comprise a dust collecting chamber which stores dirt that has been drawn into the vacuum cleaner, a vacuum generating source which generates and supplies a suction force, and a filter assembly which is disposed between the dust collecting chamber and the vacuum generating source to separate dust from the air being drawn into the vacuum cleaner.

FIG. 1 is a perspective cut-away view showing a conventional filter assembly. Referring to FIG. 1, the filter assembly 220 comprises a filter body 222 and a filter housing 221 for supporting the filter body 222. The filter body 222 is configured to have a corrugated form thereby providing a maximum surface area for optimum filtering performance, and therefore, conventional filters have successive folds. The zigzag or pleated filter is preferred since it enables easy manufacture and provides maximum surface area. However, the above-structured filter body 222 has a problem in that dust P colliding with the filter body 222 in a direction of an arrow A is likely to stick in crack D of a gap 222e of a groove 222b and collect therein. Since the collected dust is not easily detached by cleaning of the filter, it remains in the gap 222e, and the function of the filter deteriorates as a result.

### SUMMARY OF THE INVENTION

An aspect of the present invention is to solve at least the above problems and/or disadvantages and to provide at least the advantages described below. Accordingly, an aspect of the present invention is to provide an improved filter assembly for performing more efficient cleaning work, and a vacuum cleaner utilizing the same.

In order to achieve the above-described aspects of the present invention, there is provided a filter assembly comprising a filter body for filtering dust and a filter housing for supporting the filter body. The filter body is configured in the form of a corrugation having alternate ridges and grooves, wherein a gap in the groove is made inaccessible so as to prevent adhesion of the dust therein. Accordingly, detachment of the dust P becomes easy when cleaning the filter body 222, and therefore, the filter assembly 220 can maintain its performance as a new one after being cleaned. The ridges and the grooves are successively formed in a successive alternating sequence, and the grooves are rounded.

The filter assembly further comprises a blocking member for insertion into the filter body, and wherein the ridges and the grooves are disposed in a successive alternating sequence, and a blocking member is inserted in the corner of each groove.

The blocking member is substantially in the form of a trigonal prism, and the height of the blocking member is approximately a quarter of a height from the corner of the groove to the ridge.

Another aspect of the present invention is to provide a vacuum cleaner comprising a cleaner body, a suction part for drawing in air and entrained dust from a surface being cleaned, a dust collecting chamber for storing the drawn-in dust, a filter body for filtering the dust from the drawn in air, and a filter housing for supporting the filter body, the filter body being configured in the form of a corrugation having alternate ridges and grooves, wherein a gap in the groove is made inaccessible so as to prevent adhesion of the dust therein.

The ridges and the grooves are disposed in a successive alternating sequence, and the grooves are rounded.

The vacuum cleaner further comprises a blocking member for insertion into the filter body, and wherein the ridges and the grooves are disposed in a successive alternating sequence, and the blocking member is inserted into the corner of each of the grooves.

Each blocking member is substantially in the form of a trigonal prism, and the height of the blocking member is approximately a quarter of a height from the groove to the ridge.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a perspective cut-away view of a conventional filter assembly;

FIG. 2 is a perspective view showing a vacuum cleaner according to an embodiment of the present invention;

FIG. 3 is a partial cross-sectional view of a cleaner body taken approximately along a line III-III of FIG. 2;

FIGS. 4A and 4B are perspective views showing various embodiments of the filter assembly of FIG. 3;

FIG. 4C is an enlarged view of a part ‘S’ of FIG. 4A;

FIG. 5 is a diagrammatic view, taken in cross-section, of the filter assembly taken approximately along a line V-V of FIG. 4B; and

FIG. 6 is a perspective view of the filter assembly according to an embodiment of the present invention.

### DETAILED DESCRIPTION OF THE PREFERRED EMBODIMENTS

Hereinafter, a first embodiment of the present invention will be described in detail with reference to the accompanying drawing figures.

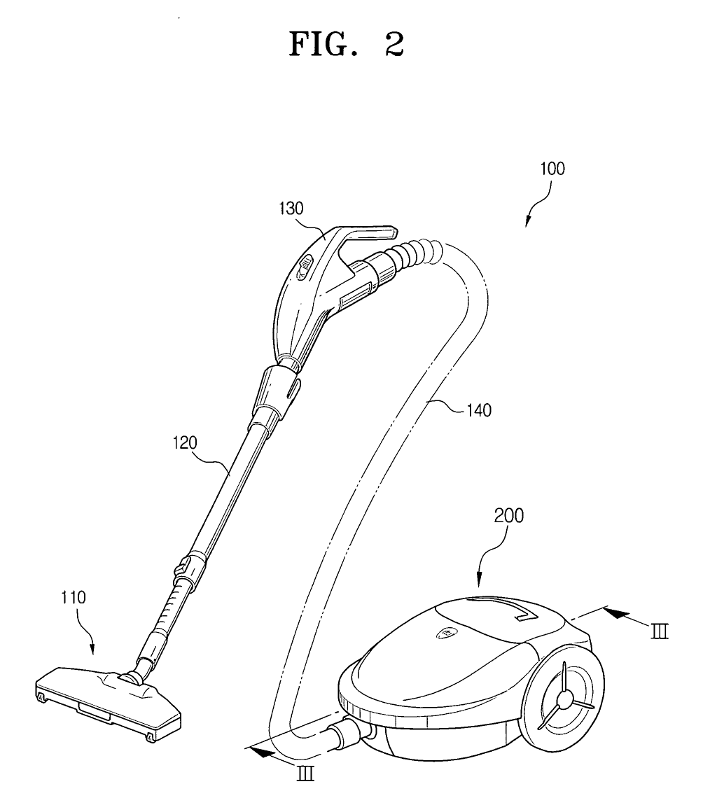

FIG. 2 is a perspective view showing a vacuum cleaner according to a first embodiment of the present invention. Referring to FIG. 2, the vacuum cleaner 100 comprises a cleaner body 200, a suction part 110 for drawing in dirt from a surface being cleaned, an operational part 130 for operating the vacuum cleaner, an extension pipe 120 for connecting the suction part 110 and the operational part 130, and a flexible hose 140 for connecting and providing enclosed fluid communication between the operational part and the cleaner body. When using the above described structure, dust on a surface being cleaned is drawn into the suction part 110, and is collected in a dust collecting chamber (not illustrated) provided in the cleaner body 200, passing through the extension pipe 120 and the flexible hose 140.

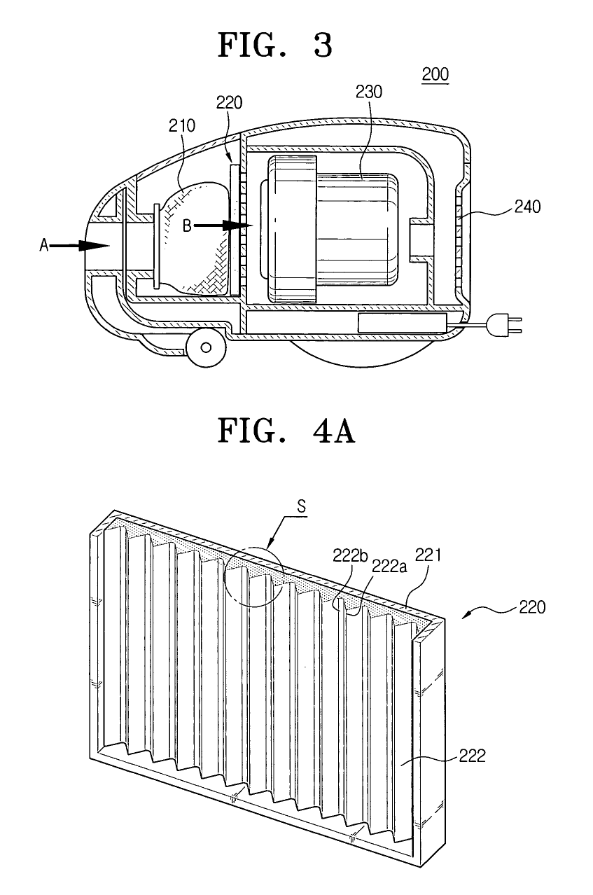

FIG. 3 is a partial cross-sectional view of the cleaner body taken approximately along the line III-III of FIG. 2. Referring to FIG. 3, the cleaner body 200 comprises a dust collecting chamber 210 in which dust is collected, a vacuum generation source 230 which supplies a suction force to draw in air and entrained dust, and a filter assembly 220 which separates the dust from the drawn-in air.

When the suction force is generated by operation of the vacuum generation source 230, the dust passes into the dust collecting chamber 210 in the direction of arrow A. Relatively larger dust particles are initially collected in the dust collecting chamber 210, and relatively finer dust particles pass through a surface of the dust collecting chamber 210, and are filtered by the filter assembly 220 as the air is moving in the direction of arrow B. The air, having passed through the filter assembly 220, is then discharged through an outlet 240.

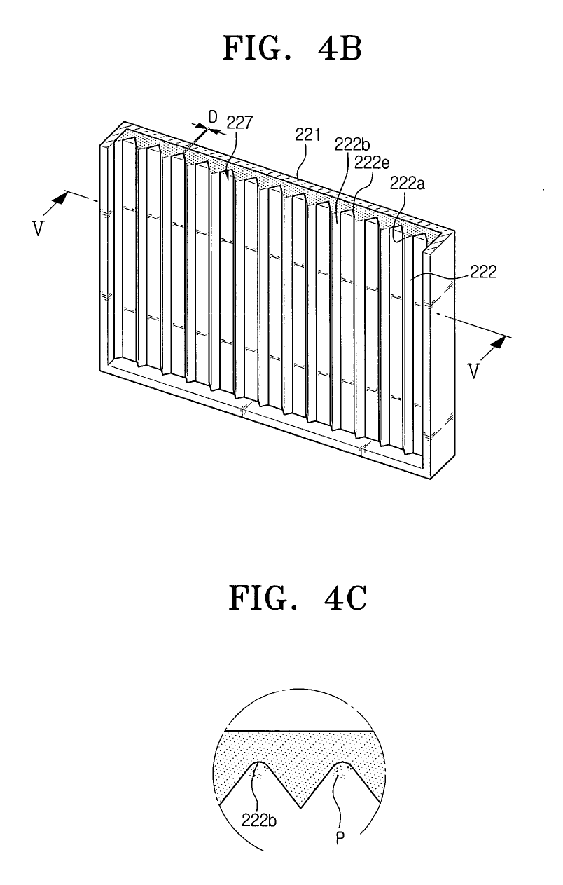

FIGS. 4A and 4B are partially cut-away perspective views showing various alternative embodiments of the filter assembly of FIG. 3, and FIG. 4C is an enlarged view of a part ‘S’ of FIG. 4A, in which like elements are provided with the same identification numerals between the different embodiments. Referring to FIGS. 4A, 4B and 4C, the filter assembly 220 comprises a filter body 222 and a filter housing 221, which supports and houses the filter body 222. The filter housing 221 is configured to completely embrace and support in a surrounding manner the filter body 222 so as to maintain the shape of the filter body 222 and permit it to perform its filtering function.

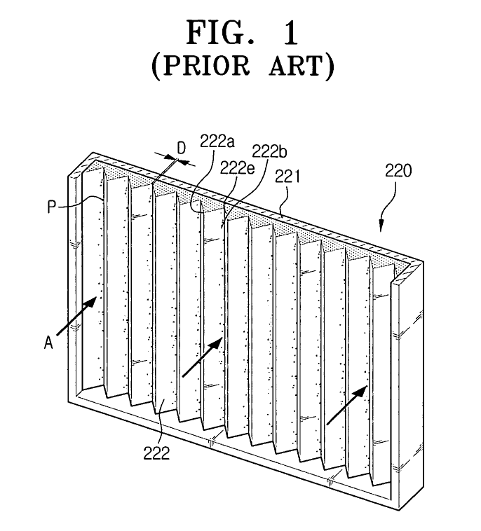

Referring to FIG. 4A, the filter body 222 is configured in the form of corrugated folds having alternating ridges 222a and grooves 222b. Since each groove 222b is rounded, as shown more clearly in the detail view of FIG. 4C, the filter body 222 does not have a gap 222e, as in the conventional filter (FIG. 1), so that adhesion of dust P in the groove 222b, and collection therein, is prevented even when the dust P collides with the groove 222b.

Referring to FIG. 4B, the filter body 222 is configured in the form of corrugated folds, which also have alternating ridges 222a and grooves 222b, and a blocking member 227 is inserted within each corner comprising grooves 222b. The filter body 222 of this embodiment is easier to manufacture than the one shown in FIG. 4A because the rounding process of the groove 222b is not required. According to the above structure, the dust P is prevented by the blocking member 227 from initially reaching the groove 222b, and therefore, the dust P is not allowed to adhere in the crack D of the gap 222e.

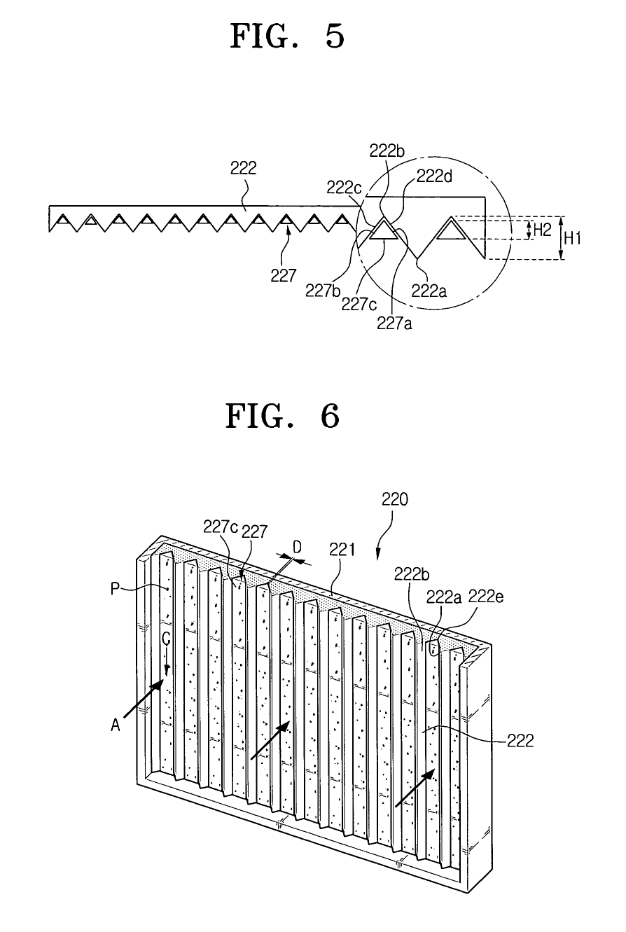

FIG. 5 is a diagrammatical cross-sectional view of the filter assembly of FIG. 4B taken approximately along a line V-V. Referring to FIG. 5, a blocking member 227 is formed as a trigonal prism for insertion into the corner of each groove 222b being disposed between two adjacent ridges 222a. The height H2 of the blocking member 227 is approximately a quarter of the height H1 from the corner of groove 222b to the top of ridge 222a, which experimentally has proved to be most preferable for convenient detachment of the collected dust P to provide maximum filtering performance. Further, in order to prevent separation of the blocking member 227 from the filter body 222, both sides 227a and 227b are attached to both slope surfaces 222c and 222d forming the sides one groove 222b, using adhesive as the attachment means.

FIG. 6 is a perspective view, in partially cross-section, of the filter assembly according to an embodiment of the present invention. Referring to FIG. 6, the dust P progressing in the direction A is prevented from initially reaching the corner of the groove 222b g, and further, the dust P colliding with an exposed face 227c is likely to fall down along the exposed face 227c in the direction of arrow C. As a result, the dust P is prevented from being collected in the crack D of the gap 222e.

According to the filter assembly 220 as described above, used in vacuum cleaner having provision to incorporate the filter assembly 220 therein, detachment of the dust P becomes easy when cleaning the filter body 222, and therefore, the filter assembly 220 can maintain its performance as good as new after being cleaned.

While the invention has been illustrated and described with reference to certain embodiments thereof, it will be understood by those skilled in the art that various changes in form and details may be made therein without departing from the spirit and scope of the invention as defined by the appended claims.

1. A filter assembly for use in a vacuum cleaner comprising:
a filter body for filtering dust; and
a filter housing for supporting the filter body,
the filter body being configured in the form of a corrugation having alternate ridges and grooves, wherein a gap in the groove is made inaccessible so as to prevent adhesion of dust therein.

2. The filter assembly of claim 1, wherein the ridges and the grooves are disposed in a successive alternating sequence, and the grooves are rounded.

3. The filter assembly of claim 1, further comprising a blocking member for insertion into the filter body, and wherein
the ridges and the grooves are disposed in a successive alternating sequence, and
a blocking member is inserted in the corner of each groove.

4. The filter assembly of claim 3, wherein each blocking member is substantially a trigonal prism.

5. The filter assembly of claim 4, wherein the height of the blocking member is approximately a quarter of the height from the groove to the ridge.

6. A vacuum cleaner comprising:
a cleaner body;
a suction part for drawing in air and entrained dust from a surface being cleaned;
a dust collecting chamber for storing the drawn-in dust;
a filter body for filtering the dust from the drawn in air; and
a filter housing for supporting the filter body,
the filter body being configured in the form of a corrugation having alternate ridges and grooves, wherein a gap in the groove is made inaccessible so as to prevent adhesion of the dust therein.

7. The vacuum cleaner of claim 6, wherein the ridges and the grooves are disposed in a successive alternating sequence and the grooves are rounded.

8. The vacuum cleaner of claim 6, further comprising a blocking member for insertion into the filter body, and wherein
the ridges and the grooves are disposed in a successive alternating sequence, and
the blocking member is inserted into the corner of each of the grooves.

9. The vacuum cleaner of claim 8, wherein each blocking member is substantially a trigonal prism.

10. The vacuum cleaner of claim 9, wherein the height of the blocking member is approximately a quarter of the height from the groove to the ridge.
